(19) United States
(12) Patent Application Publication
(10) Pub. No.: US 2004/0251143 A1
(43) Pub. Date: Dec. 16, 2004

(54) Electrolytic tin-plating solution and method for plating

(75) Inventors: Suda Kazuyuki, Saitama-shi (JP); Makoto Kondo, Kounosu-shi (JP)

Correspondence Address: EDWARDS & ANGELL, LLP, P.O. Box 55874, Boston, MA, 02205, US

(73) Assignee: Rohm and Haas Electronic Materials, L.L.C., Marlborough, MA

(21) Appl. No.: 10/788,811

(22) Filed: Feb. 27, 2004

(30) Foreign Application Priority Data
Aug. 31, 2001 (WO) PCT/JP01/07559

(51) Int. Cl. B05B 1/00; C09D 5/00; C09D 5/10

(52) U.S. Cl. 205/302; 106/1.25

(57) ABSTRACT

A tin electroplating solution, characterized in that it has a pH of 1.5 to 6.0 and comprises the following components: (1) 5 to 60 g/L of a tin (II) ion, (2) a complexing agent, (3) a surfactant and (4) 0.01 to 0.5 g/L of a bismuth (III) ion; and a method for the tin plating of electronic parts or the like which comprises using the tin electroplating solution are disclosed. The tin electroplating solution exhibits a soldering wettability being comparable with or superior to a conventional tin-lead alloy (solder) without the use of hazardous lead or an organic brightening agent.

The present application claims the benefit of International Patent Application No. PCT/JP01/07559, filed Aug. 31, 2001 which is incorporated herein by reference.

### INDUSTRIAL FIELD OF UTILIZATION

This invention is related to an electrolytic tin-plating solution and a method for electrolytic tin plating. In more detail, this invention is related to an electrolytic tin-plating solution containing no lead and to a method for electrolytic tin-plating capable of forming an electrolytic tin-plate film with excellent wettability to the solder used to connect electronic parts.

### PRIOR ART

Tin-lead alloys have many advantages, such as low cost, good electrical properties, excellent soldering wettability, etc., and have been widely used as soldering material for connecting electronic parts in various electronic devices. Tin- or solder-plating is also carried out for electronic parts made from ceramic, glass, plastic, etc., to improve the soldering wettability of electrodes and wires. However, the solder has a high content of lead, such as 5-40 weight %, which is hazardous to workers and the natural environment.

Recently, as a lead-free solder plating solution or plating film, a plating solution or plating film of tin-silver alloy, tin-copper alloy, tin-bismuth alloy, etc., has been used to replace the plating solution or plating film of tin-lead alloy. However, the plating solution or plating film of tin-silver alloy contains expensive silver and may exhibit precipitation of silver metal, since silver ions can be reduced by tin. As a result, long-term use of the plating solution will be difficult. In a different method, a complexing agent is added to shift the deposition potential of silver and form an alloy deposit of tin and silver with significantly different deposition potentials. However, the silver content in the alloy formed may increase when the current density is low. When the silver content reaches 3.5 weight % or higher, the melting point of the plating film will increase and solder wettability will decrease as the silver content increases. On the other hand, since the copper in a tin-copper alloy plating solution or the bismuth in a tin-bismuth alloy plating solution has a deposition potential closer to tin compared to silver, the plating solution has better stability than that of the tin-silver alloy plating solution. In addition, the content in the alloy formed has less variation when the current density changes. However, the tin-copper alloy plating film also has a problem. The melting point of the plating film will increase and solder wettability will decrease as the copper content increases. The tin-bismuth alloy plating film has a low melting point and excellent solder wettability. However, the tin-bismuth alloy plating film is very brittle. In order to achieve highly reliable connection, the bismuth content in the alloy must be low and it is usually in the range of 2-10 weight %.

Therefore, it is highly desirable to develop a new method for electrolytic tin plating. Tin-lead alloy has a meting point lower than that of tin and the lead present in the alloy also functions as a brightening agent. As a result, electrolytic plating of the tin-lead alloy is able to generate a fine and tightly deposited film with very stable properties. In addition, the deposited film has excellent solder wettability. On the other hand, electrolytic tin plating usually generates a rough plating film with poor solder wettability. By using a brightening agent, including organic brightening agents, such as aldehyde analogs, etc., or amine-based brightening agent, such as ammonium salt, etc., it is possible to form a fine and tightly deposited film with improved solder wettability immediately after plating. However, the content of organic substances in the plating film will increase and solder wettability may deteriorate as a function of time. For the tin or solder plating film on the electrodes and wires on the electronic parts made of ceramic, glass, plastic, etc., sufficient solder wettability can be achieved for the parts with a size of 1005 type or higher. However, when the parts has a size of 1005 type or lower, the tin-plating film may not have sufficient solder wettability, resulting in poor connection. For the electronic parts made of ceramic, glass, etc., in order to avoid erosion of the base material or metal deposition on the base material, it is necessary to use a weak acidic or neutral plating solution. Particularly, ammonium salts are very corrosive to the base material and should not be used for this purpose. Therefore, it is high desirable to develop an electrolytic tin-plating solution and a method for electrolytic tin plating using the solution, which has minimum erosion to the base material and is capable of generating a plating film with the same level of solder wettability as that of a tin-lead alloy plating film.

In other words, the purpose of this invention is to provide an electrolytic tin-plating solution and a method for electrolytic tin plating using the solution, which does not use hazardous lead and organic brightening agent and is able to generate an electrolytic tin-plating film with a solder wettability comparable with or superior to that of a conventional tin-lead alloy (solder) plating film.

### CONSTITUTION OF THE INVENTION

In order to achieve the goal described above, the inventors carried out a series of studies. As a result, it was found that the goal described above can be achieved by using an electrolytic tin-plating solution with the following composition. Thus, this invention includes the following two parts.

1. An electrolytic tin-plating solution, characterized by having a pH value of 1.5-6.0 and containing the following components:

(1) 5-60 g/L of tin(III) ion,

(2) a complexing agent,

(3) a surfactant, and

(4) 0.01-0.5 g/L of bismuth(III) ion.

2. A method for electrolytic tin plating, characterized by using the electrolytic tin-plating solution described Item 1 for electrolytic tin-plating of electronic parts.

### EMBODIMENT OF THE INVENTION

In the following, this invention is explained in detail. The electrolytic tin-plating solution of this invention contains tin(II) ion, a complexing agent, a surfactant, and bismuth(III) ion. The tin(II) ion is a divalent ion of tin from various tin compounds capable of generating the ion in a solution. Good examples of the tin compounds are tin(II) salts of an inorganic acid, such as sulfuric acid, hydrochloric acid, etc., an organic acid, such as methanesulfonic acid, citric acid, malic acid, tartaric acid, etc. The concentration of the tin(II) ion in the electrolytic tin-plating solution should be in the range of 5-60 g/L, preferably 10-30 g/L.

In this invention, a complexing agent is used to stabilize the tin(II) ion in the electrolytic tin-plating solution and can be, for example, an inorganic acid, such as pyrophosphoric acid, etc., an organic acid, such as gluconic acid, citric acid, malic acid, tartaric acid, etc.

The complexing agent can be added as a salt. Good examples of the salt are alkali metal salts, such as sodium salt, potassium salt, etc. The concentration of the complexing agent in the electrolytic tin-plating solution should be in the range of 2-10 eq/L, preferably 4-6 eq/L, with respect to the tin(II) ion or in the range of 40-300 g/L, preferably 80-200 g/L.

The surfactant used in the electrolytic tin-plating solution of this invention has the function of providing a uniform appearance of the plating film. Various surfactants are suitable for this purpose. Good examples of the surfactants are nonionic surfactants, anionic surfactants, cationic surfactants, etc. However, it is preferable to use a nonionic surfactant. More specifically, nonionic surfactants, such as polyoxyethylene lauryl ether, polyoxyethylene polyoxypropylene glycol with an average of 10 units of ethylene oxide and an average of 4 units of propylene oxide, polyoxyethylene nonyl phenyl ether with an average of 9 units of ethylene oxide, etc., are preferable. These surfactants can be used alone or as a mixture containing two or more of them.

The concentration of the surfactant in the electrolytic tin-plating solution should be in the range of 0.1-20 g/L, preferably 0.5-5.0 g/L.

In this invention, the bismuth ion is added to the electrolytic tin-plating solution to improve the solder wettability of the plating layer. However, when the electrolytic tin-plating solution contains a large amount of bismuth ions, the solution will become a tin-bismuth alloy plating solution and the plating film formed from the solution may become very brittle. Therefore, the concentration of the bismuth ion in the electrolytic tin-plating solution should be in the range of 0.01-0.5 g/L, preferably 0.02-0.2 g/L. The bismuth ion can be introduced into the plating solution by adding a bismuth salt. There is no special limitation on the bismuth salt used for this purpose, as long as the salt is able to generate bismuth(III) ions in the electrolytic tin-plating solution. Good examples of the bismuth salt are bismuth methanesulfonate, bismuth sulfate, bismuth citrate, etc.

The pH value of the electrolytic tin-plating solution of this invention should be in the range of 1.5-6.0, preferably 3.5-4.5. By having a pH value in the range listed above, erosion of the base material and metal deposition on the base material will not occur when the tin plating is carried out on the electrodes and wires of electronic parts made of ceramic, glass, etc., and an excellent tin-plating film can be obtained.

The electrolytic tin-plating solution of this invention may also contain other additives, such as an antioxidant, conducting agent, anode-dissolving agent, etc. The antioxidant is used to prevent the conversion of tin(II) to tin(IV) and formation or precipitation of metal hydroxide, etc. Good examples of the antioxidant are hydroquinone, catechol, resorcinol, ascorbic acid, etc. The concentration of the antioxidant in the electrolytic tin-plating solution should be in the range of 0.2-5.0 g/L, preferably 0.5-2.0 g/L.

The conducting agent is used only when the voltage is low during the plating process. As long as the function mentioned above can be achieved, any common conducting agent can be used. Good examples of the conducting agent are methanesulfonic acid, sulfuric acid, gluconic acid, etc. The concentration of the conducting agent in the electrolytic tin-plating solution should be in the range of 20-200 g/L, preferably 50-150 g/L.

The anode-dissolving agent is used to achieve smooth dissolution of the anode and to maintain a continuous operation at a constant metal ion concentration. As long as the function mentioned above can be achieved, any common anode-dissolving agent can be used. Good examples of the anode-dissolving agent are methanesulfonic acid, sulfuric acid, gluconic acid, etc.

The concentration of the anode-dissolving agent in the electrolytic tin-plating solution should be in the range of 20-200 g/L, preferably 50-150 g/L.

The electrolytic tin-plating solution of this invention is suitable for electrolytic tin plating of various electronic parts, such as chip resistance, chip condenser, chip thermistor, etc.

The electrolytic tin-plating solution of this invention can be used for electrolytic tin plating of various electronic parts under the following conditions:

| | |
|---|---|
| Current density: | 0.05-0.5 A/dm² |
| Temperature: | 20-30° C. |
| Time: | 240 - 24 minutes (5 μm) |

The plating film obtained with the method of this invention should contain bismuth at a concentration of 0.1 weight % or lower. Since the concentration is much lower than the co-deposition concentration of the tin-bismuth alloy, which is in the range of 2-10 weight %, the plating film has no problem of brittleness and the properties of plating film are very close to those of a tin-plating film. In addition, the plating film is very fine and tight and has excellent solder wettability comparable with or superior to that of a conventional tin-lead alloy plating film. The electrolytic tin-plating film formed with the method of this invention can be used to replace a solder film on various electronic parts requiring soldering. Moreover, the electrolytic tin-plating film may also be a primer layer, and a different plating film, such as a nickel plating film, etc., can be further formed on the tin-plating film.

### PRACTICAL EXAMPLES

In the following, this invention is explained in more detail with practical examples. However, these practical examples should not be considered as limitations of this invention. In addition, the composition of the tin-plating solution as well as the conditions used for the plating process may also be modified according to requirements on the product.

### Practical Example 1

TABLE 1

| Tin-plating solution composition | | |
|---|---|---|
| Tin(II) sulfate (as tin ion) | 15 | g/L |
| Potassium citrate | 140 | g/L |
| Sodium methanesulfonate | 100 | g/L |
| Polyoxyethylene polyoxypropylene glycol ether | 2.0 | g/L |
| (ethylene oxide: average of 10 units, | | |
| propylene oxide: average of 4 units) | | |
| Catechol | 0.5 | g/L |
| Bismuth methanesulfonate (as bismuth ion) | 0.05 | g/L |
| Distilled water | remainder | |
| pH | 4.0 | |
| Nickel-plating solution composition | | |
| Nickel sulfate | 240 | g/L |
| Nickel chloride | 45 | g/L |
| Boric acid | 30 | g/L |
| pH | 4.5 | |
| Plating film | | |
| Nickel-plating film thickness: | 5 | μm |
| Tin-plating film thickness: | 5 | μm |
| Plating process | | |
| (i) Placing the parts in a container | | |
| (ii) Washing with water | | |
| (iii) Acid activation | | |
| (iv) Washing with water | | |
| (v) Nickel plating (0.4 A/dm², 60 min) | | |
| (vi) Washing with water | | |
| (vii) Tin plating (0.1-0.3 A/dm², 120 - 40 min) | | |
| (viii) Washing with water | | |
| (ix) Drying | | |

### Practical Example 2

TABLE 2

| Tin-plating solution composition | | |
|---|---|---|
| Tin(II) sulfate (as tin ion) | 15 | g/L |
| Potassium citrate | 140 | g/L |
| Sodium methanesulfonate | 100 | g/L |
| Polyoxyethylene nonyl phenyl ether | 5.0 | g/L |
| (ethylene oxide: average 9 units) | | |
| Hydroquinone | 1.0 | g/L |
| Bismuth methanesulfonate (as bismuth ion) | 0.05 | g/L |
| Distilled water | remainder | |
| pH | 6.0 | |
| Nickel plating solution composition | | |
| Nickel sulfate | 240 | g/L |
| Nickel chloride | 45 | g/L |
| Boric acid | 30 | g/L |
| pH | 4.5 | |
| Plating film | | |
| Nickel plating film thickness: | 5 | μm |
| Tin-plating film thickness: | 5 | μm |
| Plating process | | |
| (i) Placing the parts in a container | | |
| (ii) Washing with water | | |
| (iii) Acid activation | | |
| (iv) Washing with water | | |
| (v) Nickel plating (0.4 A/dm², 60 min) | | |
| (vi) Washing with water | | |
| (vii) Tin plating (0.1-0.3 A/dm², 120 - 40 min) | | |
| (viii) Washing with water | | |
| (ix) Drying | | |

### Practical Example 3

TABLE 3

| Tin-plating solution composition | | |
|---|---|---|
| Tin(II) methanesulfonate (as tin ion) | 15 | g/L |
| Sodium gluconate | 140 | g/L |
| Sodium methanesulfonate | 100 | g/L |
| Polyoxyethylene lauryl ether | 2.0 | g/L |
| Catechol | 0.5 | g/L |
| Bismuth methanesulfonate (as bismuth ion) | 0.05 | g/L |
| Distilled water | remainder | |
| pH | 4.0 | |
| Nickel plating solution composition | | |
| Nickel sulfate | 240 | g/L |
| Nickel chloride | 45 | g/L |
| Boric acid | 30 | g/L |
| pH | 4.5 | |
| Plating film | | |
| Nickel plating film thickness: | 5 | μm |
| Tin-plating film thickness: | 5 | μm |
| Plating process | | |
| (i) Placing the parts in a container | | |
| (ii) Washing with water | | |
| (iii) Acid activation | | |
| (iv) Washing with water | | |
| (v) Nickel plating (0.4 A/dm², 60 min) | | |
| (vi) Washing with water | | |
| (vii) Tin plating (0.1-0.3 A/dm², 120 - 40 min) | | |
| (viii) Washing with water | | |
| (ix) Drying | | |

### Practical Example 4

TABLE 4

| Tin-plating solution composition | | |
|---|---|---|
| Tin(II) sulfate (as tin ion) | 15 | g/L |
| Sodium gluconate | 140 | g/L |
| Sodium methanesulfonate | 100 | g/L |
| Polyoxyethylene lauryl ether | 2.0 | g/L |
| Hydroquinone | 1.0 | g/L |
| Bismuth methanesulfonate (as bismuth ion) | 0.05 | g/L |
| Distilled water | remainder | |
| pH | 6.0 | |
| Nickel plating solution composition | | |
| Nickel sulfate | 240 | g/L |
| Nickel chloride | 45 | g/L |
| Boric acid | 30 | g/L |
| pH | 4.5 | |
| Plating film | | |
| Nickel plating film thickness: | 5 | μm |
| Tin-plating film thickness: | 5 | μm |
| Plating process | | |
| (i) Placing the parts in a container | | |
| (ii) Washing with water | | |
| (iii) Acid activation | | |
| (iv) Washing with water | | |
| (v) Nickel plating (0.4 A/dm², 60 min) | | |
| (vi) Washing with water | | |
| (vii) Tin plating (0.1-0.3 A/dm², 120 - 40 min) | | |
| (viii) Washing with water | | |
| (ix) Drying | | |

### Practical Example 5

TABLE 5

| Tin-plating solution composition | | |
|---|---|---|
| Tin(II) sulfate (as tin ion) | 45 | g/L |
| Sodium gluconate | 140 | g/L |
| Sodium methanesulfonate | 100 | g/L |
| Polyoxyethylene lauryl ether | 2.0 | g/L |
| Hydroquinone | 1.0 | g/L |
| Bismuth methanesulfonate (as bismuth ion) | 0.05 | g/L |
| Distilled water | remainder | |
| pH | 4.0 | |
| Nickel plating solution composition | | |
| Nickel sulfate | 240 | g/L |
| Nickel chloride | 45 | g/L |
| Boric acid | 30 | g/L |
| pH | 4.5 | |
| Plating film | | |
| Nickel plating film thickness: | 5 | μm |
| Tin-plating film thickness: | 5 | μm |
| Plating process | | |
| (i) Placing the parts in a container | | |
| (ii) Washing with water | | |
| (iii) Acid activation | | |
| (iv) Washing with water | | |
| (v) Nickel plating (0.4 A/dm², 60 min) | | |
| (vi) Washing with water | | |
| (vii) Tin plating (0.1-0.3 A/dm², 120 - 40 min) | | |
| (viii) Washing with water | | |
| (ix) Drying | | |

### Practical Example 6

TABLE 6

| Tin-plating solution composition | | |
|---|---|---|
| Tin(II) sulfate (as tin ion) | 15 | g/L |
| Sodium gluconate | 140 | g/L |
| Sodium methanesulfonate | 100 | g/L |
| Polyoxyethylene lauryl ether | 2.0 | g/L |
| Catechol | 0.5 | g/L |
| Bismuth methanesulfonate (as bismuth ion) | 0.05 | g/L |
| Distilled water | remainder | |
| pH | 4.0 | |
| Nickel plating solution composition | | |
| Nickel sulfate | 240 | g/L |
| Nickel chloride | 45 | g/L |
| Boric acid | 30 | g/L |
| pH | 4.5 | |
| Plating film | | |
| Nickel plating film thickness: | 5 | μm |
| Tin-plating film thickness: | 5 | μm |
| Plating process | | |
| (i) Placing the parts in a container | | |
| (ii) Washing with water | | |
| (iii) Acid activation | | |
| (iv) Washing with water | | |
| (v) Nickel plating (0.4 A/dm², 60 min) | | |
| (vi) Washing with water | | |
| (vii) Tin plating (0.1-0.3 A/dm², 120 - 40 min) | | |
| (viii) Washing with water | | |
| (ix) Drying | | |

### Comparative Example 1

### Using no Bismuth

TABLE 7

| Tin-plating solution composition | | |
|---|---|---|
| Tin(II) sulfate (as tin ion) | 27 | g/L |
| Sodium gluconate | 140 | g/L |
| Sodium methanesulfonate | 100 | g/L |
| Polyoxyethylene lauryl ether | 2.0 | g/L |
| Catechol | 0.5 | g/L |
| Distilled water | remainder | |
| pH | 4.0 | |
| Nickel plating solution composition | | |
| Nickel sulfate | 240 | g/L |
| Nickel chloride | 45 | g/L |
| Boric acid | 30 | g/L |
| pH | 4.5 | |
| Plating film | | |
| Nickel plating film thickness: | 5 | μm |
| Tin-plating film thickness: | 5 | μm |
| Plating process | | |
| (i) Placing the parts in a container | | |
| (ii) Washing with water | | |
| (iii) Acid activation | | |
| (iv) Washing with water | | |
| (v) Nickel plating (0.4 A/dm², 60 min) | | |
| (vi) Washing with water | | |
| (vii) Tin plating (0.1-0.3 A/dm², 120 - 40 min) | | |
| (viii) Washing with water | | |
| (ix) Drying | | |

### Comparative Example 2

### Using no Bismuth

TABLE 8

| Tin-plating solution composition | | |
|---|---|---|
| Tin(II) sulfate (as tin ion) | 15 | g/L |
| Ammonium citrate | 140 | g/L |
| Ammonium sulfate | 50 | g/L |
| Polyoxyethylene lauryl ether | 2.0 | g/L |
| Catechol | 0.5 | g/L |
| Distilled water | remainder | |
| pH | 4.0 | |
| Nickel plating solution composition | | |
| Nickel sulfate | 240 | g/L |
| Nickel chloride | 45 | g/L |
| Boric acid | 30 | g/L |
| pH | 4.5 | |
| Plating film | | |
| Nickel plating film thickness: | 5 | μm |
| Tin-plating film thickness: | 5 | μm |
| Plating process | | |
| (i) Placing the parts in a container | | |
| (ii) Washing with water | | |
| (iii) Acid activation | | |
| (iv) Washing with water | | |
| (v) Nickel plating (0.4 A/dm², 60 min) | | |
| (vi) Washing with water | | |
| (vii) Tin plating (0.1-0.3 A/dm², 120 - 40 min) | | |
| (viii) Washing with water | | |
| (ix) Drying | | |

### Comparative Example 3

### Solder Plating

TABLE 9

| Tin-lead alloy plating solution composition | | |
|---|---|---|
| Tin(II) methanesulfonate (as tin ion) | 15 | g/L |
| Lead(II) methanesulfonate (as lead ion) | 1 | g/L |
| Sodium gluconate | 140 | g/L |
| Sodium methanesulfonate | 100 | g/L |
| Polyoxyethylene lauryl ether | 2.0 | g/L |
| Catechol | 0.5 | g/L |
| Distilled water | remainder | |
| pH | 4.0 | |
| Nickel plating solution composition | | |
| Nickel sulfate | 240 | g/L |
| Nickel chloride | 45 | g/L |
| Boric acid | 30 | g/L |
| pH | 4.5 | |
| Plating film | | |
| Nickel plating film thickness: | 5 | μm |
| Solder plating film thickness: | 5 | μm |
| Plating process | | |
| (i) Placing the parts in a container | | |
| (ii) Washing with water | | |
| (iii) Acid activation | | |
| (iv) Washing with water | | |
| (v) Nickel plating (0.4 A/dm², 60 min) | | |
| (vi) Washing with water | | |
| (vii) Solder plating (0.1-0.3 A/dm², 120 - 40 min) | | |
| (viii) Washing with water | | |
| (ix) Drying | | |

The electrolytic tin-plating films obtained in the practical examples showed uniform and non-glossy or micro-glossy appearance. The solder wettability of the electrolytic tin-plating films was evaluated with the meniscograph method by measuring the zero-cross time using a solder checker. The measurement conditions are as follows.

Zero-cross time measurement conditions

| | |
|---|---|
| Solder groove: | Sn/Pb = 60/40 |
| Solution temperature: | 230° C. |
| Dipping depth: | 0.1 mm |
| Dipping speed: | 1 mm/second |
| Dipping time: | 5 seconds |
| Flux: | Rosin-based inert type |
| Moisture resistance test: | 60° C., 90%, 96 hr |

The results obtained from the evaluation are shown in Table 10. As shown in the table, after the moisture resistance test, the zero-cross time of the electrolytic tin-plating films obtained in the practical examples is within 1 second, which is the same level as the solder wettability of the tin-lead plating film.

TABLE 10

| | | | Solder wettability | |
|---|---|---|---|---|
| | | | (zero-cross time) | |
| | Erosion on | Deposition of | Before moisture- | After moisture- |
| Examples | ceramic part | ceramic part | resistance test | resistance test |
| Practical Example 1 | O | O | 0.3 | 0.7 |
| Practical Example 2 | O | O | 0.3 | 0.8 |
| Practical Example 3 | O | O | 0.3 | 0.6 |
| Practical Example 4 | O | O | 0.3 | 0.7 |
| Practical Example 5 | O | O | 0.3 | 0.8 |
| Practical Example 6 | O | O | 0.3 | 0.6 |
| *Comparative Example 1 | O | O | 0.3 | 2.2 |
| *Comparative Example 2 | X | X | 0.3 | >5.0 |
| *Comparative Example 3 | O | O | 0.2 | 0.6 |

### Potential Utilization in Industry

As described above, the electrolytic tin-plating solution of this invention does not contain hazardous lead and is safe to workers. In addition, since the electrolytic tin-plating solution of this invention does not use an alloy, management and handling of the plating solution is easier. The properties of the plating film show no variation when the content changes. As a result, a fine and tight plating film with uniform properties can be obtained. Finally, the electrolytic tin-plating film formed with the method of this invention has excellent solder wettability and is a connecting material very useful for various electronic parts.

What is claimed is:

1. An electrolytic tin-plating solution, having a pH value of 1.5-6.0 and comprising:
(1) 5-60 g/L of tin(II) ion,
(2) a complexing agent,
(3) a surfactant, and
(4) 0.01-0.5 g/L of bismuth(III) ion

2. The electrolytic tin-plating solution described claim 1, further comprising a conducting salt, an anode-dissolving agent or an antioxidant.

3. The electrolytic tin-plating solution described claim 1, wherein the surfactant is a nonionic surfactant.

4. A method for electrolytic tin plating, characterized by using the electrolytic tin-plating solution described claim 1 for electrolytic tin plating on electronic parts.
